(19) United States
(12) Patent Application Publication
(10) Pub. No.: US 2013/0193627 A1
(43) Pub. Date: Aug. 1, 2013

(54) Adjustable Clamping Device for Stair Assembly

(71) Applicant: Stanford P. Antoine, Brooklyn, NY (US)

(72) Inventor: Stanford P. Antoine, Brooklyn, NY (US)

(21) Appl. No.: 13/363,906

(22) Filed: Feb. 1, 2012

(51) Int. Cl. B25B 5/16

(52) U.S. Cl. 269/145

(57) ABSTRACT

An adjustable clamping device for use in temporarily securing together opposed stairway stringers about one or more stair tread members includes a body member having opposed upper and lower ends. A length adjustable first arm is connected to the body member upper end and a length adjustable second arm is connected to the body member lower end. The clamping device includes a pressure plate having a generally planar configuration and situated parallel to the body member. An actuator having a first portion is operatively coupled to the body member and to the pressure plate to selectively move the pressure plate between retracted and extended configurations. A user input is attached to a proximal end of the actuator by which a user may operate the actuator to move the pressure plate.

### BACKGROUND OF THE INVENTION

This invention relates generally to clamping devices and, more particularly, to a clamping device that is height, width, and length adjustable for clamping together the stringers or channels of a stairway.

The major components of a staircase are stringers, risers, and treads. Of course, other components such as handrails, spindles, and posts may also be included for safety and aesthetic purposes. The risers are the vertical portion of respective steps and the treads are the horizontal portions that are walked upon. The stringers are the components of a staircase that run alongside the horizontal stair treads and provide structural support for the treads that are walked on. In constructing a stair case, it is often desirable to temporarily secure the treads and risers between the stringers until they can be permanently fastened.

Various clamping devices have been proposed in the art for holding work pieces together until the work pieces are permanently fastened together, such as by glue, nails, screws, or the like. Specifically, a traditional clamp may include jaws that may be tightened about sides of a work piece such as by a winding or screwing action. Although assumably effective for their intended purposes, the existing and proposed clamping devices are not universally adjustable for length and width variations experienced when attempting to hold stair treads and risers between opposed stringers or channels. Further, existing clamping devices do not include a pressure plate specifically configured to press opposed stringers together without damaging the stringer planar surface.

Therefore, it would be desirable to have an adjustable clamping device that is configured to be length and width adjustable for squeezing opposed stairway stringers together when steps are positioned between the stringers. Further, it would be desirable to have an adjustable clamping device that can grip opposed stringers and apply selectively increased pressure without damaging any surfaces of the stringers.

### SUMMARY OF THE INVENTION

An adjustable clamping device according to a preferred embodiment of the present invention for use in temporarily securing together opposed stairway stringers about one or more stair tread members includes a body member having opposed upper and lower ends. A length adjustable first arm is connected to the body member upper end and a length adjustable second arm is connected to the body member lower end. The clamping device includes a pressure plate having a generally planar configuration and situated parallel to the body member. An actuator having a first portion is operatively coupled to the body member and to the pressure plate to selectively move the pressure plate between retracted and extended configurations. A user input is attached to a proximal end of the actuator by which a user may operate the actuator to move the pressure plate.

Therefore, a general object of this invention is to provide a clamping device for use in temporarily securing together opposed stairway stringers about one or more stair tread members includes a body member having opposed upper and lower ends.

Another object of this invention is to provide a clamping device, as aforesaid, that that is length and width adjustable for use with staircase assemblies of different dimensions.

Still another object of this invention is to provide a clamping device, as aforesaid, having a single pressure plate configured to press against a stringer and at least one griping member opposite the pressure plate for securing another stringer such that stairway tread members between the stringers are secured.

Yet another object of this invention is to provide a clamping device, as aforesaid, that is easy to use.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a clamping device according to a preferred embodiment of the present invention;

FIG. 2a is a side view of the clamping device as in FIG. 1;

FIG. 2b is an end view of the clamping device as in FIG. 1;

FIG. 2c is a top view of the clamping device as in FIG. 1;

FIG. 3a is another end view of the clamping device as in FIG. 1;

FIG. 3b is a sectional view taken along line 3b-3b as in FIG. 3a;

FIG. 4 is an exploded view of the clamping device as in FIG. 1;

FIG. 5 is a perspective view of the clamping device as in FIG. 1 in use with a pair of staircase stringers;

FIG. 6 is a perspective view of the clamping device as in FIG. 1 in use with a pair of staircase channels;

FIG. 7a is a perspective view of the pressure plate and actuator removed from the clamping device;

FIG. 7b is a side exploded view of the pressure plate and actuator as in FIG. 7a;

FIG. 8a is a perspective view of the pressure plate as in FIG. 7a; and

FIG. 8b is a perspective view of an attachment flange on the pressure plate.

### DESCRIPTION OF THE PREFERRED EMBODIMENT

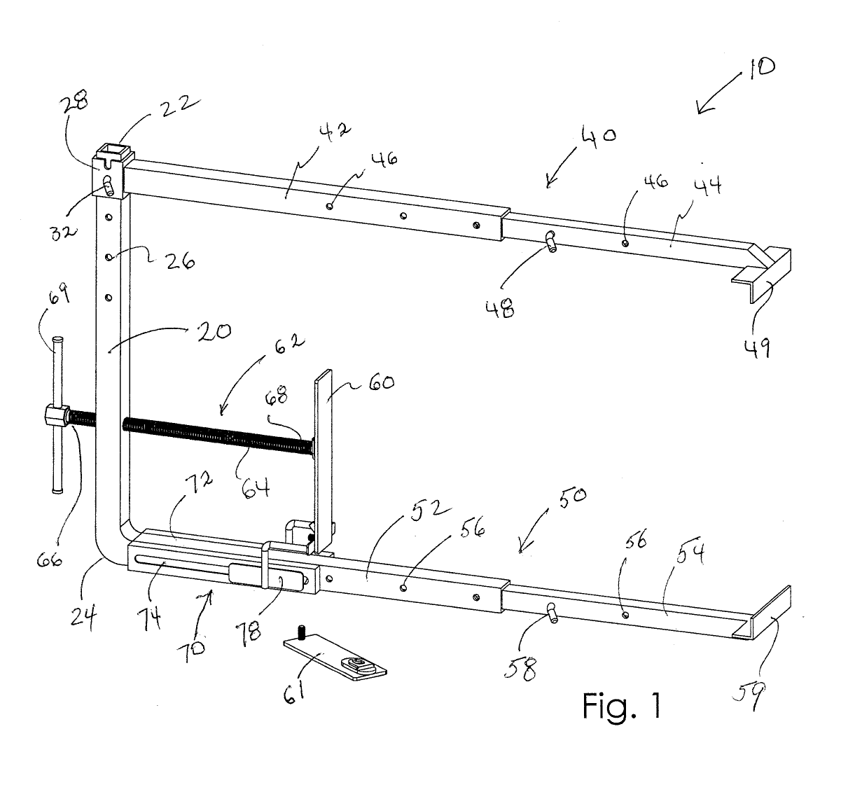

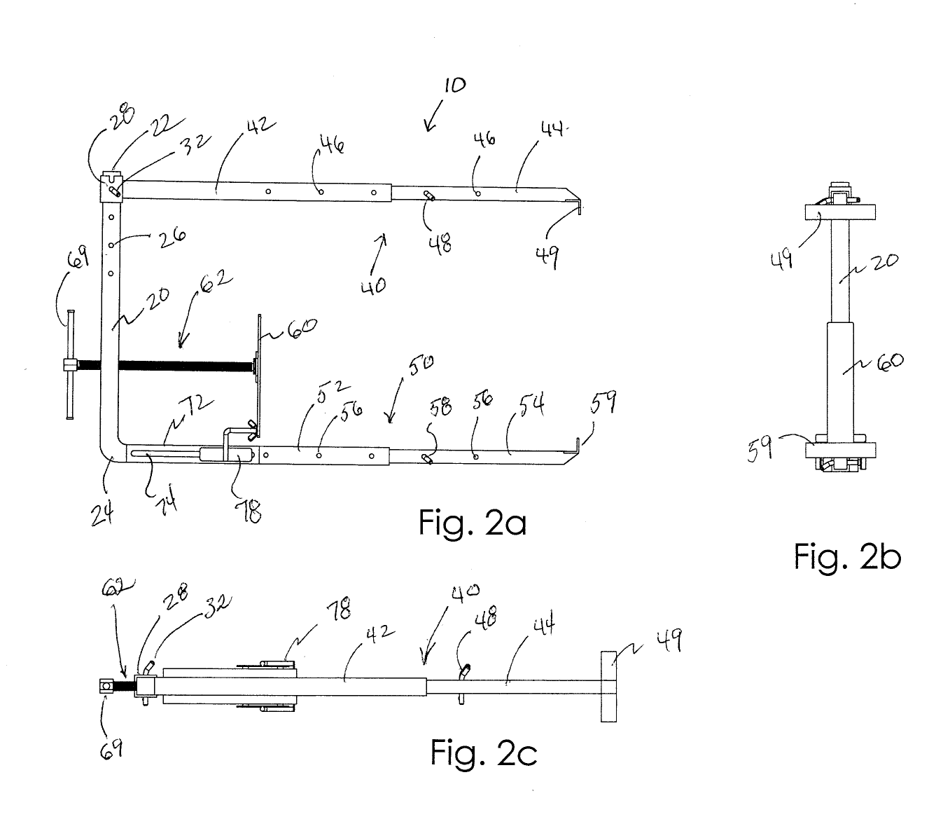

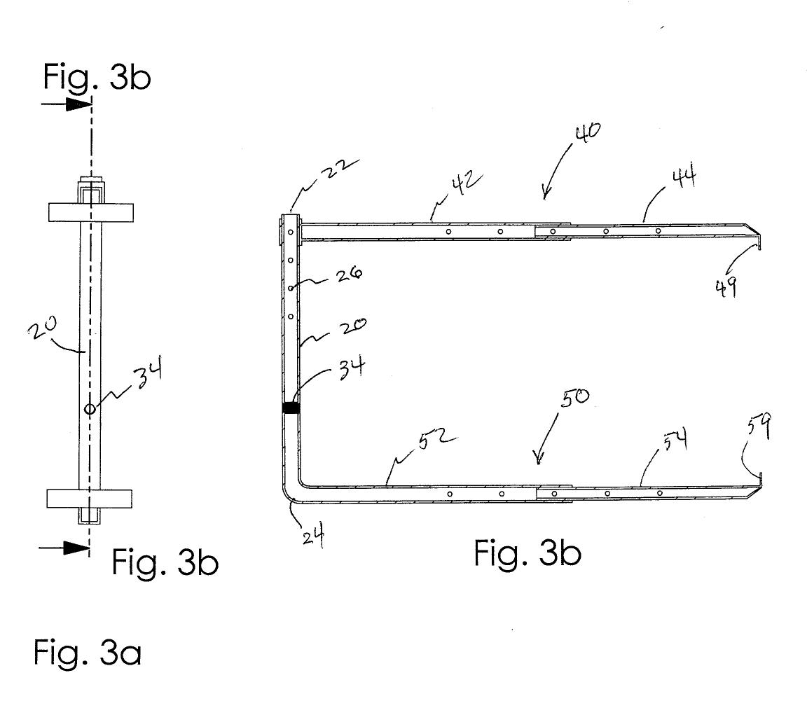

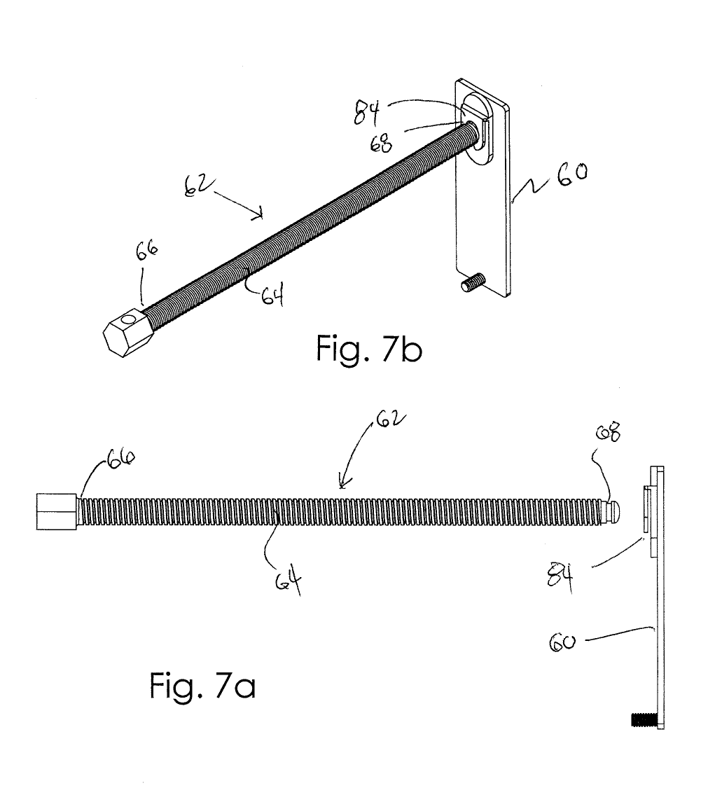

An adjustable clamping member for securing opposed stairway stringers or channels according to a preferred embodiment of the present invention will now be described in detail with reference to FIGS. 1 to 9b of the accompanying drawings. The clamping device 10 includes a body member 20, a length adjustable first arm 40, a length adjustable second arm 50, and a selectively movable pressure plate 60.

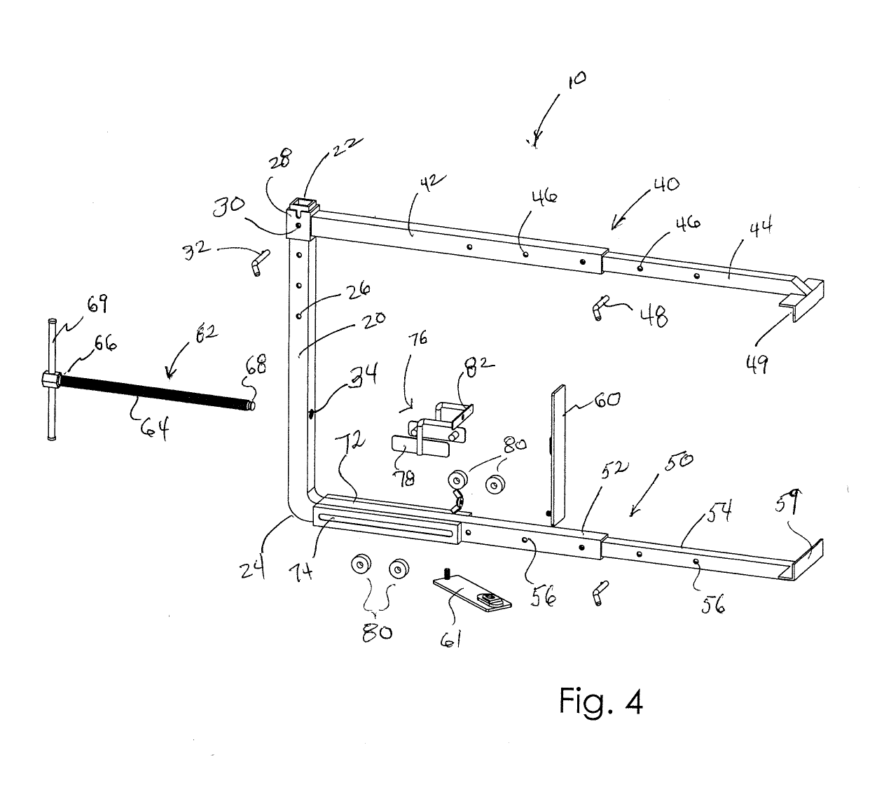

The clamping device 10 includes a body member 20 having upper 22 and lower 24 ends. Preferably, the body member 20 is constructed of hollow metal tubing, such as square metal tube stock. The body member 20 defines a plurality of spaced apart apertures 26 adjacent the upper end 22 and extending away from the upper end 22 (FIG. 4). The body member apertures 26 will be described in more detail later pertaining to attachment of the first arm 40.

The length adjustable first arm 40 is coupled to the body member 20 substantially adjacent the upper end 22 such that the first arm 40 is generally perpendicular to the body member 20 and extends outwardly therefrom (FIG. 1). More particularly, the first arm 40 includes a mounting bracket 28 configured to be removably coupled to the body member 20 by having a circumference larger than a circumference of the body member 20 so as to be slidably received onto the body member 20 and movable therealong. The bracket 28 defines a hole 30 that may be selectively aligned with one of the body member apertures 26 and held at that position when a fastener 32 is inserted through the hole 30 and selected aperture 26.

The fastener 32 may be a pin. Alternatively, one or more spring loaded fasteners positioned on the body member 20 that automatically extend through the hole 30 when selectively position would also work (not shown). It is understood that the first arm 40 may be removably coupled to the body member 20 and may be removed by sliding the bracket 28 upwardly beyond the upper end 22 of the body member 20.

The second arm 50 is coupled to the lower end 24 of the body member 20 and extends perpendicular to the body member 20 and away therefrom. The second arm 50 is parallel to the first arm 40. As shown in FIG. 1, the second arm 50 may have a unitary construction with the body member 20.

The first arm 40 may include a first portion 42 (which may also be referred to as a first arm first portion) and a second portion 44 (which may also be referred to as a first arm second portion) slidably received in the first portion 42. The first arm second portion 44 may be movable between a retracted configuration substantially inside the first arm first portion 42 and an extended configuration substantially outside the first arm first portion 42. The first arm first portion 42 and the first arm second portion 44 define a plurality of first arm adjustment apertures 46 spaced apart therealong, respectively. The respective arm portions are held in a selective position when a first arm adjustment pin 48 is inserted through selectively aligned first arm adjustment apertures 46.

Similarly, the second arm 50 may include a first portion 52 (which may also be referred to as a second arm first portion) and a second portion 54 (which may also be referred to as a second arm second portion) slidably received in the first portion 52. The second arm second portion 54 may be movable between a retracted configuration substantially inside the second arm first portion 52 and an extended configuration substantially outside the second arm first portion 52. The second arm first portion 52 and the second arm second portion 54 define a plurality of second arm adjustment apertures 56 spaced apart therealong, respectively. The respective arm portions are held in a selective position when a second arm adjustment pin 58 is inserted through selectively aligned second arm adjustment apertures 56.

The pressure plate 60 is coupled to the body member 20 in a configuration that allows a user to adjust its forward or rearward position. More particularly, the body member 20 defines a bore 34 having a threaded configuration. (A threaded boss may be positioned in the bore 34). An actuator 62 extends through the bore 34. The actuator 62 may include a first portion 64 having a threaded configuration that is complementary to the threaded configuration of the bore 34 or boss therein. The actuator 62 may also include opposed proximal 66 and distal 68 ends with respect to the body member 20. The pressure plate 60 is operatively coupled to the distal end 68 of the actuator 62 as will be further described later. An auxiliary pressure plate 61 may also be included and used as a replacement to the main pressure plate 60, the auxiliary pressure plate 61 having a smaller dimension.

An input 68 is attached to the proximal end 64 of the actuator 62 with which a user may operate the actuator 62. More particularly, the input 68 may be a handle configured to enable a user to rotate the rod clockwise or counterclockwise. As the actuator 62 is rotated according to the meshing of the threaded first portion 64 of the actuator 62 with the threaded bore 34, the pressure plate 60 is moved toward the retracted or extended configuration, respectively.

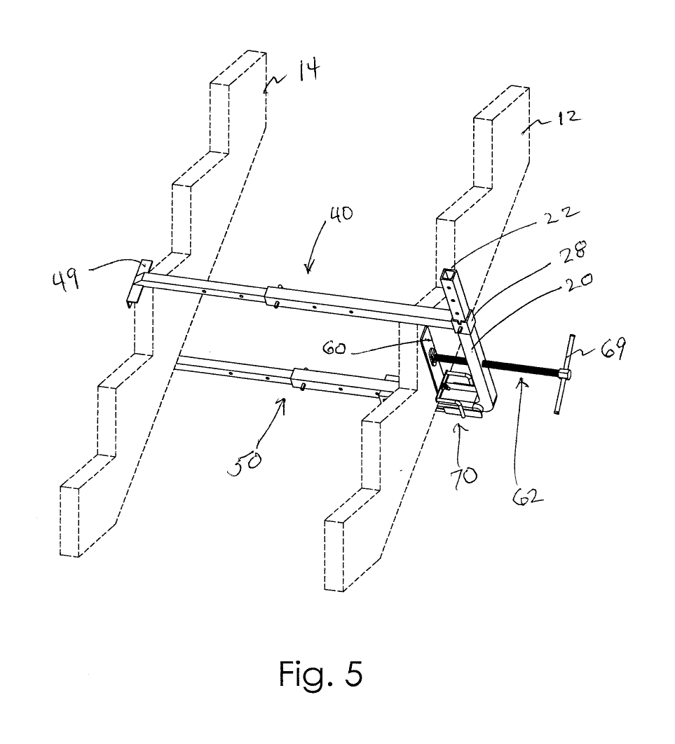

With further regard to the first 40 and second 50 arms, each arm includes a gripping member. More particularly, the first arm second portion 44 includes a free end having a first gripping member 49 attached thereto (FIG. 1). Preferably, the first gripping member 49 includes an inverted L-shaped configuration that is complementary to an upper edge of a staircase stringer (FIG. 5). Similarly, the second arm second portion 54 includes a free end having a second gripping member 59 attached thereto (FIG. 1). The second gripping member 59 includes a L-shaped configuration that is complementary to a lower edge of a staircase stringer (FIG. 5). In use, the gripping members capture one stringer 12 while the pressure plate 60 applies pressure against the other staircase stringer 14 so as to secure respective steps positioned between the stringers.

The clamping device 10 includes a pressure plate support assembly 70 (FIG. 4). The support assembly 70 may include a track member 72 fixedly mounted to the second arm second portion 54. The track member 72 defines at least one longitudinally extending rail channel 74 although a rail channel 74 on each opposing side is preferred. The support assembly 70 may also include a pressure plate support member 76 having a mounting portion 78 and a support portion 82. The mounting portion 78 includes at least one roller 80 situated in the at least one rail channel 74 although a pair of rollers 80 situated in a respective pair of channels 74 is preferred. The support portion 82 extends upwardly from the mounting portion 78 and is configured to attach to the pressure plate 60 as will be further described below. Accordingly, as the pressure plate 60 is moved by action of the actuator 62 as described above, the support member 76 is moved along the rail channel(s).

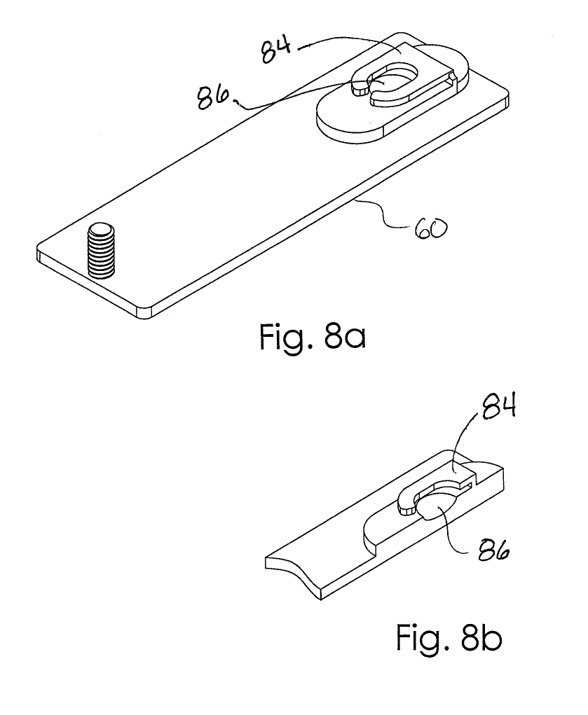

A retainer clip 84 may be situated on an inner surface of the pressure plate 60 that is configured to retain the distal end 68 of the actuator 62. The retainer clip 84 may define a recess 86 configured to receive the actuator distal end 68 and to allow it to rotate therein. (FIGS. 8a and 8b).

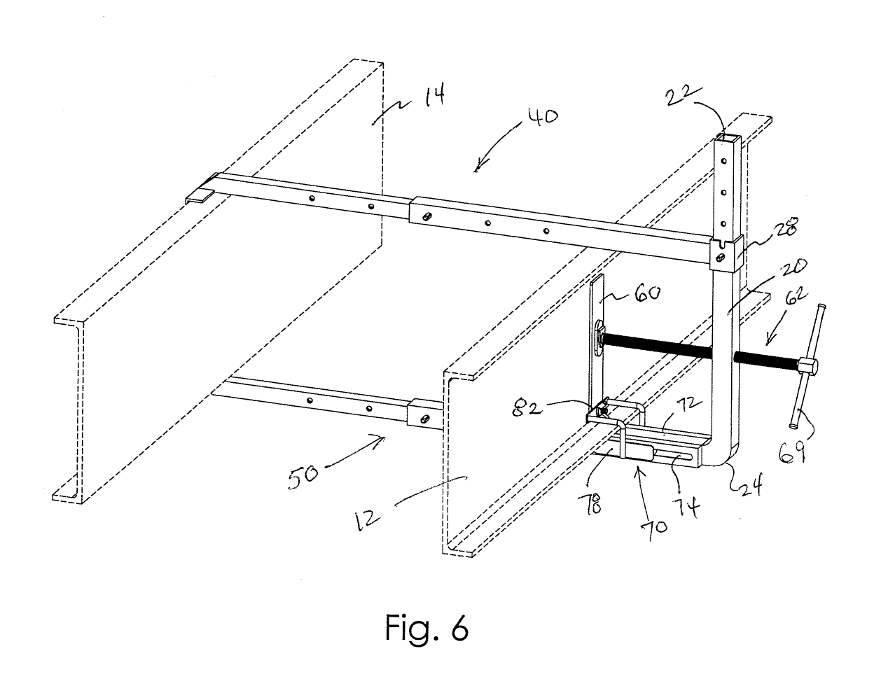

In use, the clamping device 10 may be secured to first 12 and second 14 stringers of a staircase so as to urge them toward one another and, accordingly, to secure stair tread members (not shown) in place therebetween. Specifically, the second portions of the first and second arms may be slidably moved to respective extended configurations so that respective gripping members may be positioned to grip upper and lower edges of a distant stringer 14 (FIGS. 5 and 6). The arm portions may be locked at an appropriate length with fasteners as described above. Then, the actuator 62 may be rotated by action of the input 68 to move the actuator 62 toward an extended configuration. The actuator 62 may be moved until it is applying a desired amount of pressure against the nearest 12 of the pair of stringers.

It is understood that while certain forms of this invention have been illustrated and described, it is not limited thereto except insofar as such limitations are included in the following claims and allowable functional equivalents thereof.

1. An adjustable clamping device for use in temporarily securing together opposed stairway stringers about one or more stair tread members, said adjustable clamping device comprising:
a body member having opposed upper and lower ends;
a length adjustable first arm connected to said body member upper end, said first arm being generally perpendicular to and extending away from said body member;
a length adjustable second arm connected to said body member lower end, said second arm being generally perpendicular to and extending away from said body member;
a pressure plate having a generally planar configuration and situated parallel to said body member;
an actuator having a first portion operatively coupled to said body member and having a distal end relative to said body member that is operatively coupled to said pressure plate, said actuator being operable to move said pressure plate between a retracted configuration substantially adjacent said body member and an extended configuration displaced from said body member; and
a user input attached to a proximal end of said actuator configured to selectively operate said actuator to move said pressure plate between said retracted and said extended configurations.

2. The adjustable clamping device as in claim 1, wherein:
said first arm is generally parallel to said second arm; and
said first arm is coupled to said body member a selectable distance from said body member upper end.

3. The adjustable clamping device as in claim 2, wherein said first arm is removably coupled to said body member.

4. The adjustable clamping device as in claim 3, wherein:
said body member defines a plurality of spaced apart apertures extending away from said body member upper end;
said first arm includes a mounting bracket that defines a hole, said mounting bracket having a configuration that is slidable along said first arm, said mounting bracket being selectively coupled to said body member when a fastener is inserted into said mounting bracket hole and a respective body member aperture.

5. The adjustable clamping device as in claim 1, wherein:
said first arm includes a first arm first portion and a first arm second portion slidably received in said first arm first portion, said first arm second portion being movable between a retracted configuration substantially inside said first arm first portion and an extended configuration substantially outside said first arm first portion; and
said second arm includes a second arm first portion and a second arm second portion slidably received in said second arm first portion, said second arm second portion being movable between a retracted configuration substantially inside said second arm first portion and an extended configuration substantially outside said second arm first portion.

6. The adjustable clamping device as in claim 5, wherein:
said first arm first portion and said first arm second portion include a plurality of first arm adjustment apertures, said first arm being selectively secured at a selected length when a pin is inserted into respectively aligned first arm adjustment apertures; and
said second arm first portion and said second arm second portion include a plurality of second arm adjustment apertures, said second arm being selectively secured at a selected length when a pin is inserted into respectively aligned second arm adjustment apertures.

7. The adjustable clamping device as in claim 6, wherein:
said body member includes a bore having a threaded configuration; and
said first portion of said actuator has a threaded configuration and is positioned to extend through said bore, said actuator causing said pressure plate to move toward said retracted configuration or toward said extended configuration when rotated clockwise or counterclockwise in said bore, respectively.

8. The adjustable clamping device as in claim 7, wherein said pressure plate is removably coupled to said distal end of said actuator.

9. The adjustable clamping device as in claim 1, wherein said user input is a handle.

10. The adjustable clamping device as in claim 5, wherein said first arm is removably coupled to said body member upper end.

11. The adjustable clamping device as in claim 5, wherein:
said first arm second portion includes a free end having a first gripping member; and
said second arm second portion includes a free end having a second gripping member.

12. The adjustable clamping device as in claim 11, wherein:
said first gripping member includes an inverted L-shaped configuration that is complementary to an edge of the stairway stringer; and
said second gripping member includes an L-shaped configuration that is complementary to an edge of another stairway stringer.

13. The adjustable clamping device as in claim 11, further comprising a pressure plate support assembly, comprising:
a track member fixedly mounted to said second arm first portion that defines at least one rail channel;
a pressure plate support member that includes a mounting portion having at least one roller situated in said at least one rail channel and a support portion connected to said mounting portion;
wherein said support portion is releasably coupled to said pressure plate such that said pressure plate support member is movable along said rail channel when said pressure plate is moved by action of said actuator.

14. The adjustable clamping device as in claim 5, further comprising a pressure plate support assembly, comprising:
a track member fixedly mounted to said second arm first portion that defines at least one rail channel;
a pressure plate support member that includes a mounting portion having at least one roller situated in said at least one rail channel and a support portion connected to said mounting portion;
wherein said support portion is releasably coupled to said pressure plate such that said pressure plate support member is movable along said rail channel when said pressure plate is moved by action of said actuator.

15. The adjustable clamping device as in claim 1, further comprising:
a pressure plate support member having a mounting portion operatively coupled to said second armmember and having a support portion extending upwardly from said mounting portion that is coupled to said pressure plate, said support member mounting portion being configured to move along said second armmember when said pressure plate is moved relative to said body member.

16. The adjustable clamping device as in claim 15, further comprising:
a track member fixedly attached to said second armportion, said track member defining at least one rail channel; and
wherein said mounting portion of said pressure plate support member includes at least one roller situated in said at least one rail channel such that said pressure plate support member is movable along said rail channel when said pressure plate is moved by action of said actuator.
